(19) United States
(12) Patent Application Publication
(10) Pub. No.: US 2026/0077495 A1
(43) Pub. Date: Mar. 19, 2026

(54) ROBOT APPARATUS

(71) Applicant: FANUC CORPORATION, Yamanashi (JP)

(72) Inventors: Koichi NISHIMURA, Yamanashi (JP); Yakumo GOI, Yamanashi (JP); Kenichirou IKEDA, Yamanashi (JP)

(21) Appl. No.: 18/994,061

(22) PCT Filed: Sep. 12, 2022
(86) PCT No.: PCT/JP2022/034033

§ 371 Date: Jan. 14, 2025

(51) Int. Cl. B25J 9/16; B25J 5/00; B25J 9/00

(52) U.S. Cl. CPC B25J 9/1661; B25J 5/007; B25J 9/0009; B25J 9/1669

(57) ABSTRACT

A robot apparatus according to an aspect of the present disclosure includes a robot arm mechanism mounted on a base, and a controller to control the robot arm mechanism to execute a predetermined task. The controller controls the robot arm mechanism to move the base.

### RELATED APPLICATIONS

The present application is a National Phase of International Application No. PCT/JP2022/034033 filed Sep. 12, 2022.

### TECHNICAL FIELD

The present invention relates to a robot apparatus at least one of position and orientation of which can be changed.

### BACKGROUND ART

With recent technological advances, robots are used in various environments. Due to their improved safety, robots can now be not only used by being fixed to the floor in a conventional way, but also moved and used where and when needed by being mounted on hand carts or automated guided vehicles (AGVs) (for example, Patent Literature 1).

### CITATION LIST

### Patent Literature

Patent Literature 1: Japanese Unexamined Patent Application Publication No. 2011-173218

### SUMMARY

### Problem to be Solved

However, the moving method using a hand cart requires that a worker move the cart and, if the robot is moved frequently, requires a worker be near the robot at all times, which reduces the effect of reducing the number of workers by introducing the robot. On the other hand, the moving method using an AGV requires no operation by a worker unlike the method using a hand cart, but requires a control device, a drive device, etc. that constitute the AGV, making the equipment expensive as a whole, which limits the work for which an AGV can be introduced due to cost-effectiveness.

Therefore, a technique capable of changing at least one of the position and the orientation of the robot without introducing large-scale equipment is desired.

### Solution to Problem

A robot apparatus according to the present disclosure includes a robot arm mechanism mounted on a base, and a controller to control the robot arm mechanism to execute a predetermined task. The controller controls the robot arm mechanism to move the base.

### BRIEF DESCRIPTION OF THE DRAWINGS

FIG. 1 shows a robot system according to a first embodiment.

FIG. 2 is a hardware configuration diagram of a controller shown in FIG. 1.

FIG. 3 is a functional block diagram of the controller shown in FIG. 1.

FIG. 4 shows a robot system according to a first modification of the first embodiment.

FIG. 5 shows a robot system according to a second modification of the first embodiment.

FIG. 6A to FIG. 6C show robot systems according to a third modification of the first embodiment.

FIG. 7 shows a robot system according to a second embodiment.

FIG. 8 shows a robot system according to a modification of the second embodiment.

FIG. 9 shows a robot system according to a third embodiment.

FIG. 10A to FIG. 10D show robot systems according to a fourth embodiment.

### DETAILED DESCRIPTION

Hereinafter, robot systems according to embodiments of the present invention will be described with reference to the drawings. In the following description, constituent elements having substantially the same function and configuration are denoted by the same reference numeral, and repetitive descriptions will be given only where necessary.

One feature of the robot systems according to the present embodiments are that a robot arm mechanism is mounted on a movable base, and the base is moved by an operation of the robot arm mechanism. Since the robot arm mechanism is mounted on the base, the robot arm mechanism is moved together with the base. Since the robot arm mechanism functions as a drive source for driving the movement of the base, a drive source for driving the movement of the base need not be provided separately. In addition, since the robot arm mechanism for executing a predetermined task is also used to move the base, there is no need to equip a dedicated hand for moving the base, so that costs can be reduced as well as the size of the hand.

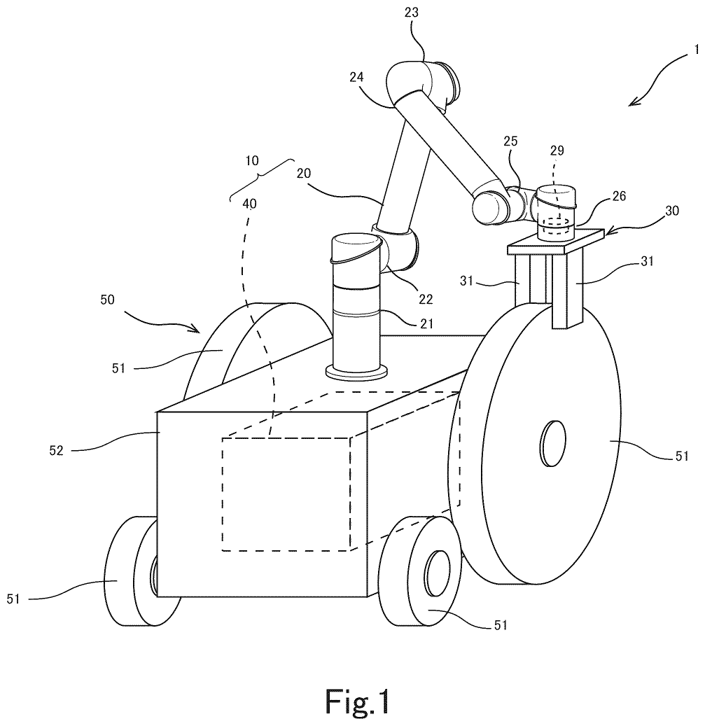

As shown in FIG. 1, a robot system 1 according to a first embodiment includes a robot apparatus 10 and a cart 50. The robot apparatus 10 includes a robot arm mechanism 20 and a controller 40 that controls the robot arm mechanism 20. The robot arm mechanism 20 is mounted on a cart 50 as a movable base. The robot arm mechanism 20 includes a plurality of joint portions 21, 22, 23, 24, 25, 26. For example, each of the joint portions 21, 22, 23, 24, 25, 26 includes a motor as a drive source for driving the joint portion and an encoder for detecting the rotational position of the motor. The robot arm mechanism 20 also includes a force sensor 29. For example, the force sensor 29 is provided in at least one of the plurality of joint portions 21, 22, 23, 24, 25, 26. The output of the force sensor 29 is sequentially input to the controller 40. In the first embodiment, the output of the force sensor 29 is used to detect collision of the cart 50 with an obstacle. Therefore, as long as the sensor output can be used for collision detection, the type of the sensor is not limited to the force sensor. For example, a torque sensor, an acceleration sensor, or the like can be used instead of the force sensor 29.

The robot arm mechanism 20 includes a hand 30 suitable for execution of a predetermined task. In the first embodiment, it is assumed that the robot arm mechanism 20 is equipped with a hand 30 having a pair of fingers 31 that can be opened and closed, suitable for workpiece picking operations.

The cart 50 consists of a rectangular parallelepiped base frame 52 with four wheels 51 on its front, back, left, and right at the bottom. The cart 50 is not self-propelled, and does not have a drive device for driving the wheels 51, a controller for controlling the operation of the wheels, or the like. The robot arm mechanism 20 is fixed to the upper surface of the base frame 52. The controller 40 that controls the robot arm mechanism 20 is accommodated in the base frame 52 of the cart 50.

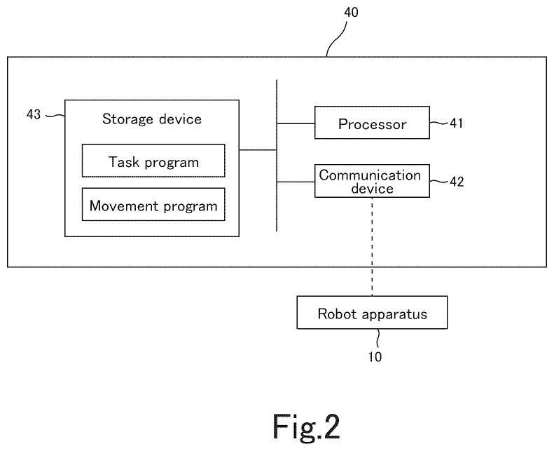

As shown in FIG. 2, the controller 40 is configured by connecting hardware such as a communication device 42 and a storage device 43 to a processor 41 such as a CPU. The communication device 42 controls transmission and reception of data to and from the robot apparatus 10. The storage device 43 is provided by an HDD, an SSD, or the like. The storage device 43 stores a task program for causing the robot arm mechanism 20 to execute a predetermined task and a movement program for moving the cart 50 on which the robot arm mechanism 20 is mounted to a predetermined position and orientation. The task program and the movement program describe teaching positions of the hand reference point, teaching postures, operation commands, and the like in accordance with the procedure.

When the movement program stored in the storage device 43 is executed by the processor 41, the controller 40 functions as a robot control unit 45, a data reception unit 46, a storage unit 47, and a collision detection unit 48, and controls the robot arm mechanism 20 to move the cart 50.

The robot control unit 45 supplies current to a servo motor for driving the joint portions 21, 22, 23, 24, 25, 26 of the robot arm mechanism 20 and a servo motor for driving the hand 30, based on a movement position command and an opening/closing operation command of the hand 30 which are defined in the movement program. The servo motors are driven by current supplied from the controller 40. The robot arm mechanism 20 thereby executes the operation defined in the movement program. Specifically, the joint portions 21, 22, 23, 24, 25, 26 are driven to move the hand 30 to a grasping position where a wheel 51 is disposed between the pair of fingers 31. Next, the hand 30 is driven to gasp the wheels 51 with the pair of fingers 31. Then, with the wheels 51 gripped by the pair of fingers 31, the joint portions 21, 22, 23, 24, 25, 26 are driven to move the hand 30 from the grasping position along the circumferential direction of the wheel 51. By having the robot arm mechanism 20 execute these operations repeatedly, the robot arm mechanism 20 can be moved together with the cart 50.

The data reception unit 46 receives output data of the force sensor 29 mounted on the robot arm mechanism 20. The output data of the force sensor received by the data reception unit 46 is stored in the storage unit 47.

The collision detection unit 48 detects that the cart 50 has collided with an obstacle, based on the output of the force sensor 29 provided in the robot arm mechanism 20. The collision detection unit 48 calculates a load based on the output of the force sensor 29 when the cart 50 is moved in a state where there is no obstacle, for example, and holds the calculated load as a reference load, calculates the difference between the reference load and a load based on the output of the force sensor 29 when the cart 50 is actually moved, and detects that the cart 50 has collided with an obstacle when the difference is larger than a threshold value. Since the collision of the cart 50 can be detected using the existing force sensor 29 of the robot arm mechanism 20, there is no need to provide the cart 50 with a sensor for collision detection, so that the existing cart 50 can be used, which contributes to cost reduction.

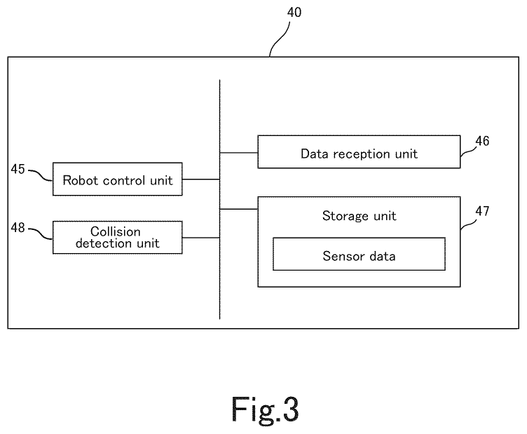

According to the robot system 1 of the first embodiment described with reference to FIG. 1 to FIG. 3, the robot arm mechanism 20 is mounted on the movable cart 50, and a wheel 51 of the cart 50 can be rotated by directly grasping the wheel 51 of the cart 50 with the pair of fingers 31 of the robot arm mechanism 20 and moving the wheel 51 along the circumferential direction. Thereby, the robot arm mechanism 20 can be moved together with the cart 50. Since the movement of the cart 50 is driven by the robot arm mechanism 20, the cart 50 does not need to be self-propelled, and an existing cart can be used.

If the robot arm mechanism 20 has a hand 30 that can grasp a wheel 51, there is no need to equip a special device or mechanism only for moving the cart 50, and it is sufficient to simply prepare a movement program for moving the cart 50. In this way, an existing cart 50 can be used, and furthermore, the robot arm mechanism 20 does not need to be equipped with special hardware to move the cart 50.

Further, in the robot system 1 according to the first embodiment, collision of the cart 50 with an obstacle can be detected based on the output of the force sensor 29 provided in the robot arm mechanism 20. Since collision of the cart 50 can be detected using the sensor already mounted on the robot arm mechanism 20, the cart 50 does not need to be equipped with a collision detection sensor, and the robot arm mechanism also does not need to be equipped with a collision detection device. As described above, according to the robot system 1 of the first embodiment, it is possible to configure a system capable of moving the robot arm mechanism 20 at a lower cost than systems including AGVs.

Note that, in the first embodiment, the robot arm mechanism 20 only executes the operation of grasping and rotating a wheel 51 of the cart 50, but the operation of the robot arm mechanism 20 is not limited to this. For example, if the cart 50 has a mechanism for locking the rotation of the wheels 51, the controller 40 may control the robot arm mechanism 20 to execute the operations of releasing and locking the locking mechanism when the cart 50 starts to move and when the cart 50 stops to move.

The robot system 1 according to the first embodiment may include a detection device, such as a sensor, for detecting the position of the cart 50, and the controller 40 controls the robot arm mechanism 20 based on the output of the sensor. For example, a camera, an optical sensor, or the like can be used as the detection device. If the robot arm mechanism 20 is equipped with a wrist camera or the like, the output of the camera can be used as the sensor for detecting the position of the cart 50.

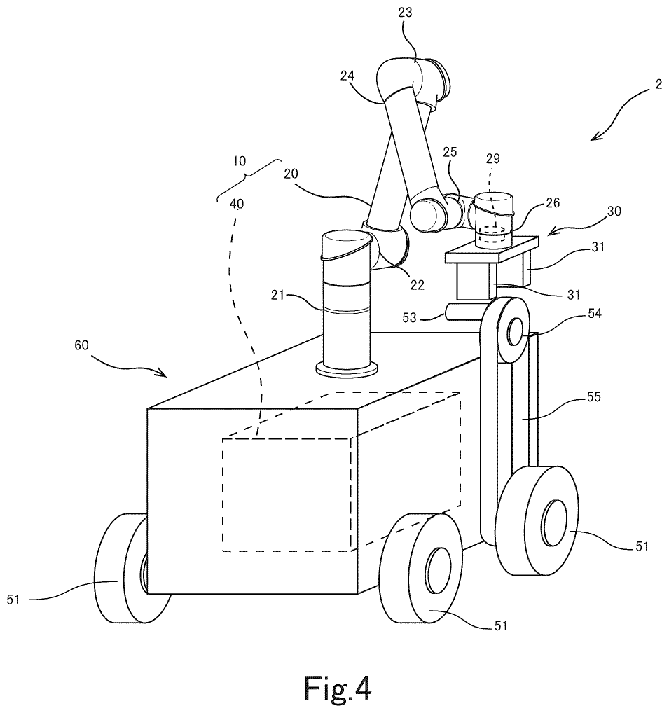

FIG. 4 shows a robot system 2 according to a first modification of the first embodiment. The second modification is different from the first embodiment in the structure of the cart on which the robot arm mechanism 20 is mounted. Accordingly, the operation control of the robot arm mechanism 20 for moving the cart is also different from that of the first embodiment.

As shown in FIG. 4, the cart 60 is configured by adding, to the cart 50, a rotary member 54, a handle 53 for rotating the rotary member 54, and a transmission mechanism 55 for transmitting the rotational force of the rotary member 54 to the wheel 51. The controller 40 controls the robot arm mechanism 20 to rotate the handle 53. When a rotation operation of the handle 53 is performed by the robot arm mechanism 20, the rotational force is transmitted to the wheel 51 through the transmission mechanism 55, whereby the wheel 51 of the cart 60 is rotated, and the robot arm mechanism 20 can be moved together with the cart 50.

In the robot system 1 of the first embodiment shown in FIG. 1, the wheel 51 rolling on the floor is directly grasped by the robot arm mechanism 20. On the other hand, in the robot system 2 of the first modification shown in FIG. 4, the handle 53 dedicated to the operation of the wheel 51 is grasped by the robot arm mechanism 20. Therefore, from the hygienic point of view, the robot system 2 according to the first modification shown in FIG. 4 is superior to the robot system 1 according to the first embodiment shown in FIG. 1. In addition, only the handle 53, the rotary member 54, and the transmission mechanism 55 need to be added to the existing cart 50. Therefore, even if the modification cost of the existing cart 50 is taken into consideration, the robot system 2 according to the first modification can constitute a system capable of moving the robot arm mechanism 20 at a cost lower than systems including AGVs.

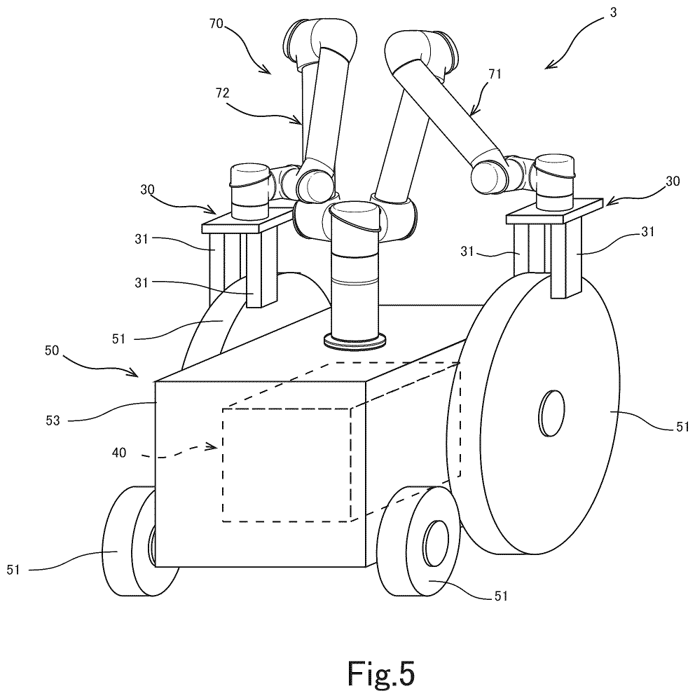

FIG. 5 shows a robot system 3 according to a second modification of the first embodiment. As shown in FIG. 5, the robot system 3 according to the second modification employs a dual-arm robot arm mechanism 70 as the robot arm mechanism mounted on the cart 50. The dual-arm robot arm mechanism 70 has a pair of arms 71, 72 that can be independently controlled and operated. Each of the pair of arms 71, 72 is equipped with a hand 30 having a pair of fingers 31. The controller 40 controls the robot arm mechanism 70 to rotate a pair of wheels 51 of the cart 50 with the pair of arms 71, 72. Thus, the robot arm mechanism 70 can be moved together with the cart 50. By controlling the robot arm mechanism 70 to rotate the pair of wheels 51 of the cart 50 at different rotational speeds, the cart 50 can be moved in a curved line. This is a major advantage of moving the cart 50 with the dual-arm robot arm mechanism 70. Therefore, in terms of expanding the range of movement, the robot system 3 in the second modification is superior to the robot system 1 according to the first embodiment.

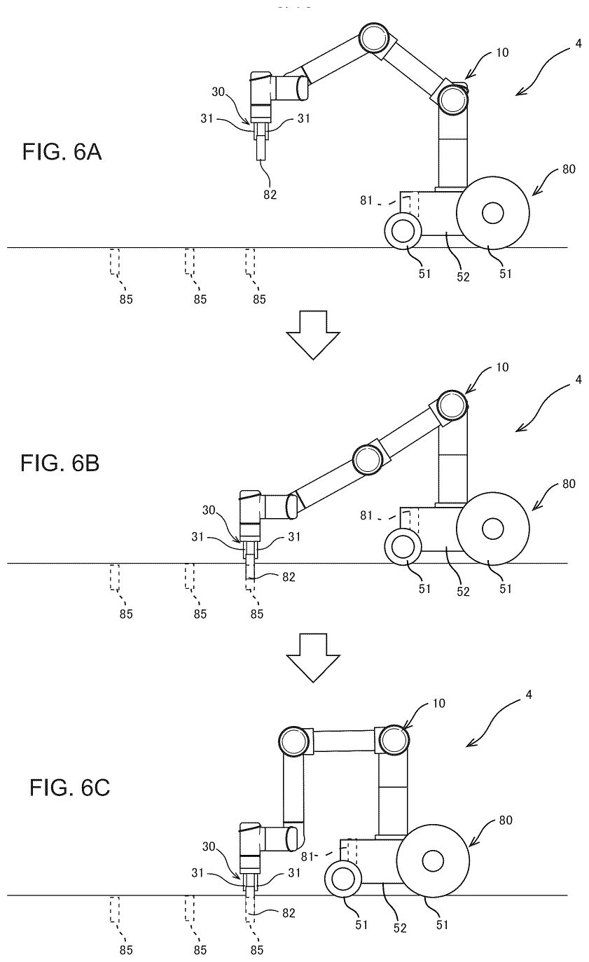

FIG. 6A to FIG. 6C show robot systems 4 according to a third modification of the first embodiment. The third modification is different from the first embodiment in the operation control of the robot arm mechanism 20 for moving the cart. As shown in FIG. 6A to FIG. 6C, in the robot system 4 according to the third modification, a cart 80 is provided with a housing portion 81 for housing a bar 82, and the floor on which the cart 80 travels is provided with a plurality of recesses 85 into which the bar can be inserted, formed along the moving path of the cart. The controller 40 controls the robot arm mechanism 20 to move the cart 80. Specifically, the joint portions 21, 22, 23, 24, 25, 26 and the hand 30 are driven in order to grasp and take out the bar 82 housed in the housing portion 81 of the cart 80 with the pair of fingers 31 (see FIG. 6A). Next, the joint portions 21, 22, 23, 24, 25, 26 are driven in order to insert the bar 82 into a recess 85 formed in the floor in a state where the bar 82 is grasped by the pair of fingers 31 (see FIG. 6B). Next, the joint portions 21, 22, 23, 24, 25, 26 are driven to move the hand 30 toward the cart 80. At this time, since the bar 82 grasped by the robot arm mechanism 20 is inserted into the recess 85, the hand side of the robot arm mechanism 20 is fixed to the floor, and the cart 80, to which the base side of the robot arm mechanism 20 is fixed, is movable. Therefore, the cart 80 is pulled toward the hand 30 of the robot arm mechanism 20 (see FIG. 6C). In this way, by driving the joint portions 21, 22, 23, 24, 25, 26 of the robot arm mechanism 20 in a state where the bar 82 grasped by the robot arm mechanism 20 is inserted into the recess 85 formed in the floor, the cart 80 can be pulled toward the recess 85, and the robot arm mechanism 20 can be moved together with the cart.

According to the robot system 4 of the third modification shown in FIG. 6A to FIG. 6C, the robot arm mechanism 20 can be moved together with the cart 80 toward the recess 85; therefore, the movement path is not limited to a straight path. Therefore, with the configuration shown in FIG. 6A to FIG. 6C, even when the dual-arm robot arm mechanism 70 as shown in FIG. 4 is not used, the robot arm mechanism 20 can be moved together with the cart 80 in a curved line.

In addition, since the bar 82 only needs to be inserted into the recess 85, the bar 82 does not need to be the one grasped by the robot arm mechanism 20, but may be the one integrally formed with the robot arm mechanism 20 or the one attached to the robot arm mechanism 20. In other words, even if the robot arm mechanism 20 does not have a grasping function or a suction function and cannot grasp or suck the bar 82, the robot arm mechanism 20 can be moved together with the cart 80 only by providing the bar-shaped projection on the robot arm mechanism 20 and controlling the operation of the robot arm mechanism 20 shown in FIG. 6A to FIG. 6C. Since the robot system 4 according to the third modification shown in FIG. 6A to FIG. 6C does not limit the type of the hand 30, it can be said that the application range is wider than the robot systems shown in FIG. 1, FIG. 4, and FIG. 5.

Further, providing the housing portion 81 for housing the bar 82 in the cart 80 or providing the bar-shaped projection on the robot arm mechanism 20 is not a major change, and the additional cost thereof can be kept to a minimum. In the case where the bar-shaped projection is provided on the robot arm mechanism 20, the projection may be provided at a position that does not interfere with the normal operation of the robot arm mechanism 20. In FIG. 6A to FIG. 6C, the recesses 85 are formed in the floor on which the cart 80 travels, but it is not always necessary that the recesses 85 are formed in the floor, and the recesses 85 into which the bar 82 is inserted may be provided on or around the moving path of the cart 80. Providing the recesses 85 in a structure fixed to the floor is more advantageous in terms of safety and cost than providing the recesses 85 in the floor, and from the viewpoint of safety, it can be said that the robot system 4 according to the third modification is equivalent to the robot system 1 according to the first embodiment.

In the first embodiment shown in FIG. 1, FIG. 4, FIG. 5, and FIG. 6A to FIG. 6C, the wheel 51, the handle 53, or the bar 82 is grasped utilizing the opening and closing operation of the hand 30. However, the operation of the hand 30 utilized is not limited to the opening and closing operation. For example, the suction operation of the hand 30 can be utilized. For example, when the robot apparatuses 10 shown in FIG. 1 and FIG. 4 utilize the suction operation, driving the joint portions 21, 22, 23, 24, 25, 26 of the robot arm mechanism 20 in a state where the hand 30 is sucked to a part of the frame of the wheel 51 causes the wheel 51 to be rotated, and the robot arm mechanism 20 to be moved together with the cart 50. When the robot apparatus 10 shown in FIG. 6A to FIG. 6C utilizes the suction operation, the robot arm mechanism 20 can be moved together with the cart 80 by inserting the suctioned bar 82 into a recess 85.

As described above, according to the robot systems 1, 2, 3, 4 described with reference to FIG. 1, FIG. 4, FIG. 5, and FIG. 6A to FIG. 6C, the cart can be moved utilizing the operation of the robot arm mechanism and the grasping operation or suction operation of a widely used existing hand; therefore, it is not necessary to have a large-scale device or structure only for moving the cart, and the robot system including the cart can be configured at a lower cost than systems including AGVs while realizing the movement of the robot arm mechanism 20 as in the case of AGVs.

In the first embodiment, the robot arm mechanism 20 is mounted on the cart 50, but the mechanism on which the robot arm mechanism 20 is mounted is not limited to the cart 50 as long as the robot arm mechanism 20 can be moved.

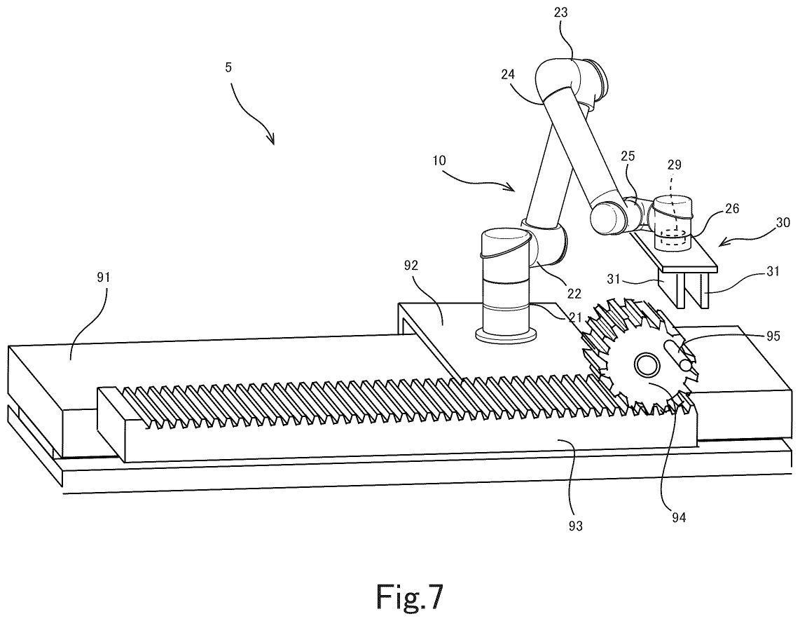

FIG. 7 shows a robot system 5 according to a second embodiment. In the second embodiment, the robot arm mechanism 20 is mounted on a slider mechanism. Specifically, as shown in FIG. 7, a rail 9191 is laid in the moving range of the robot arm mechanism 20, and the robot arm mechanism 20 is mounted on a base 92 movable with respect to the rail 91. The rail 91, together with the base 92, constitutes the slider mechanism. A rack 93, which is a bar-shaped or plate-shaped gear, is attached to the rail 91. A pinion gear 94, which is a circular gear, is meshed with the rack 93. A handle 95 for rotating the pinion gear 94 is attached to the pinion gear 94. The controller 40 controls the robot arm mechanism 20 to rotate the handle 95. A rotation operation of the handle 95 by the robot arm mechanism 20 causes the pinion gear 94 to rotate on the rack 93 in one direction. At this time, the hand 30 side of the robot arm mechanism 20 is fixed to the pinion gear 94, and the base 92, to which the base side of the robot arm mechanism 20 is fixed, is movable along rail 91. In addition, the rack 93 is attached parallel to the rail 91. That is, when the handle 95 is rotated by the robot arm mechanism 20, the pinion gear 94 moves in one direction along the rack 93, and the movement of the pinion gear 94 allows the robot arm mechanism 20 to move in one direction along the rail 91 together with the base 92.

In this way, the robot system according to the second embodiment has the same effects as in the first embodiment. That is, the movement of the base 92 is driven by the rotational operation of the pinion gear 94 by the robot arm mechanism 20; therefore, a drive source for driving the movement of the base 92 and a control device for controlling the movement of the base 92 are not necessary. Further, since the rotation operation of the pinion gear 94 by the robot arm mechanism 20 is realized by the opening/closing operation of the hand 30 and the rotation operation of each joint portion of the existing robot arm mechanism 20, it is not necessary to provide a special mechanism or device only for moving the base 92; it is sufficient to prepare a rotation program for rotating the pinion gear 94. Since an existing slider mechanism can be used and the robot arm mechanism 20 does not need to be equipped with a dedicated mechanism or device for moving the base 92 of the slider mechanism, the robot system 5 according to the second embodiment can configure a system capable of moving the robot arm mechanism 20 at a lower cost than systems including AGVs.

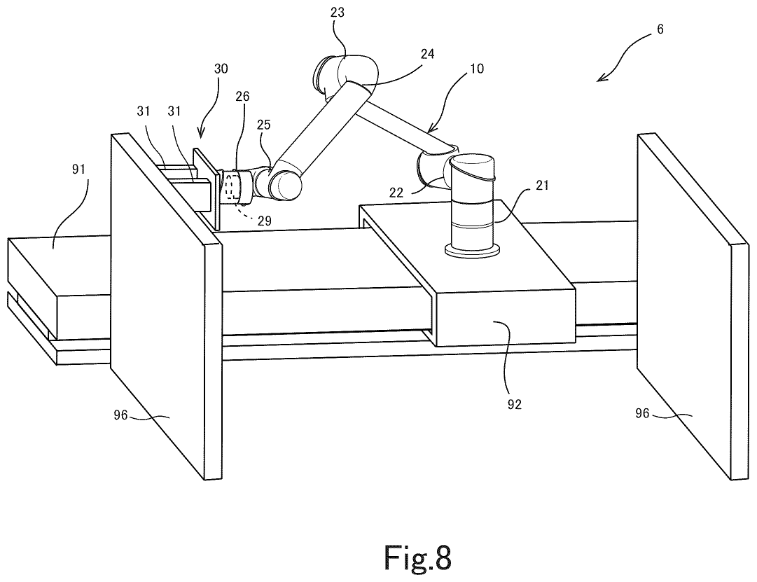

FIG. 8 shows a robot system 6 according to a modification of the second embodiment. As shown in FIG. 8, in the modification of the second embodiment, a wall 96 is provided as a structure at a position close to the rail 91, instead of the rack 93 and the pinion gear 94 of the second embodiment. Typically, the wall 96 is oriented orthogonally to the rail 91 at least within a movable range of a hand reference point (for example, an opening/closing center position of a pair of fingers) of the hand 30 of the robot arm mechanism 20 mounted on the base 92 movably provided on the rail 91. The controller 40 controls the robot arm mechanism 20 to move the base 92 using the wall 96. Specifically, the joint portions 21, 22, 23, 24, 25, 26 are driven to bring the hand 30 of the robot arm mechanism 20 into contact with the wall 96. Next, the joint portions 21, 22, 23, 24, 25, 26 are driven to move the hand 30 along the rail 91 toward the wall 96. At this time, the hand 30 side of the robot arm mechanism 20 is fixed to the wall 96, and the base side of the robot arm mechanism 20, that is, the base 92, on which the robot arm mechanism 20 is mounted, is movable along the rail 91. Therefore, by driving the joint portions 21, 22, 23, 24, 25, 26 to move the hand 30 along the rail 91 toward the wall 96, the robot arm mechanism 20 can be moved together with the base 92 away from the wall 96. Of course, the structure is not limited to the wall 96, but can be any structure that is fixed to the installation surface and can be pushed by the robot arm mechanism 20. Further, a plurality of structures may be provided, and they may not be of the same type.

In this way, the robot system 6 according to the modification of the second embodiment has the same effects as in the second embodiment. That is, the structure 96 fixed to the floor only has to be placed near the rail 91, and an existing slider mechanism can be used, and furthermore, the robotic device does not need to be equipped with a dedicated mechanism or device for moving the base 92 of the slider mechanism. Therefore, according to the robot system 6 of the modification the second embodiment, it is possible to configure a system capable of moving the robot arm mechanism 20 at a lower cost than systems including AGVs.

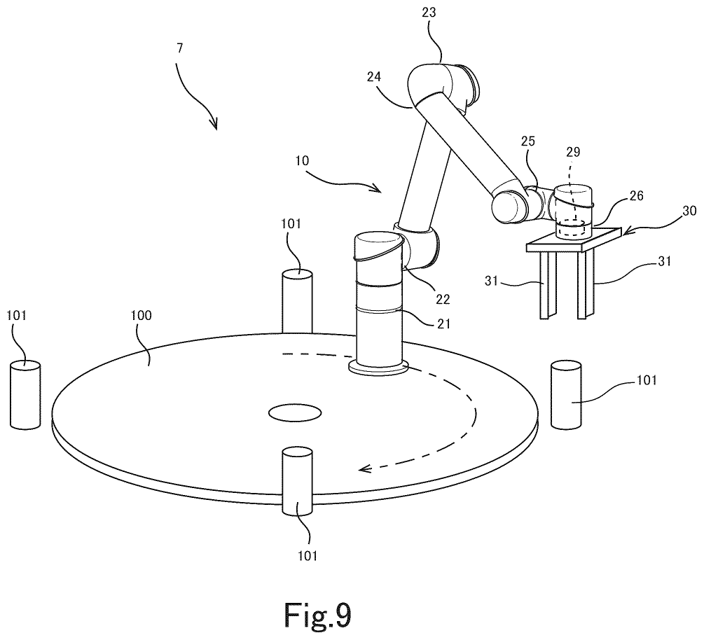

FIG. 9 shows a robot system 7 according to a third embodiment. In the third embodiment, the robot arm mechanism 20 is mounted on a rotary table 100.

Specifically, as shown in FIG. 9, the robot arm mechanism 20 is fixed at the rotational center position of the rotary table 100 or at a position offset from the rotational center. When the robot arm mechanism 20 is fixed at a position offset from the rotational center of the rotary table 100, the robot arm mechanism 20 can move along a circular path. A handle 101 is provided on the installation surface on which the rotary table 100 is installed. The controller 40 controls the robot arm mechanism 20 to rotate the rotary table 100. Specifically, the joint portions 21, 22, 23, 24, 25, 26 and the hand 30 are driven in order to grasp the handle 101 with the pair of fingers 31. Next, the joint portions 21, 22, 23, 24, 25, 26 are driven to move the hand 30 in a circumferential direction of the rotary table 100. At this time, the hand side of the robot arm mechanism 20 is fixed to the handle 101, and the rotary table 100, to which the base side of the robot arm mechanism 20 is fixed, is rotatable; therefore, the rotary table 100 can be rotated in a direction opposite to the moving direction of the hand 30. Thus, at least one of the position and the orientation of the robot arm mechanism 20 mounted on the rotary table 100 can be changed.

Here, the hand side of the robot arm mechanism 20 is fixed to the floor by grasping the handle 101 with the robot arm mechanism 20, but the method is not limited to this as long as the hand side of the robot arm mechanism 20 can be fixed to the floor. For example, the hand side of the robot arm mechanism 20 may be fixed to the floor by bringing the hand of the robot arm mechanism 20 into contact with the floor.

In this way, the robot system 7 according to the third embodiment has the same effects as in the first embodiment. That is, since the movement of the rotary table 100 is driven by the operation of the robot arm mechanism 20, a drive source for driving the movement of the rotary table 100 and a control device for controlling the movement of the rotary table 100 are not necessary. In addition, the operation of grasping the handle 101 by the robot arm mechanism 20 can be realized by the opening/closing operation of the hand 30 of an existing robot arm mechanism 20 and the rotation operations of the joint portions. Therefore, the robot arm mechanism 20 does not need to be equipped with a special mechanism or device only for moving the rotary table 100, and only a rotation program for rotating the rotary table 100 needs to be prepared. Since an existing rotary table 100 can be used and the robot arm mechanism 20 does not need to be equipped with a special mechanism or device for rotating the rotary table 100, the robot system 7 according to the third embodiment can constitute a system capable of moving the robot arm mechanism 20 at a lower cost than systems including AGVs.

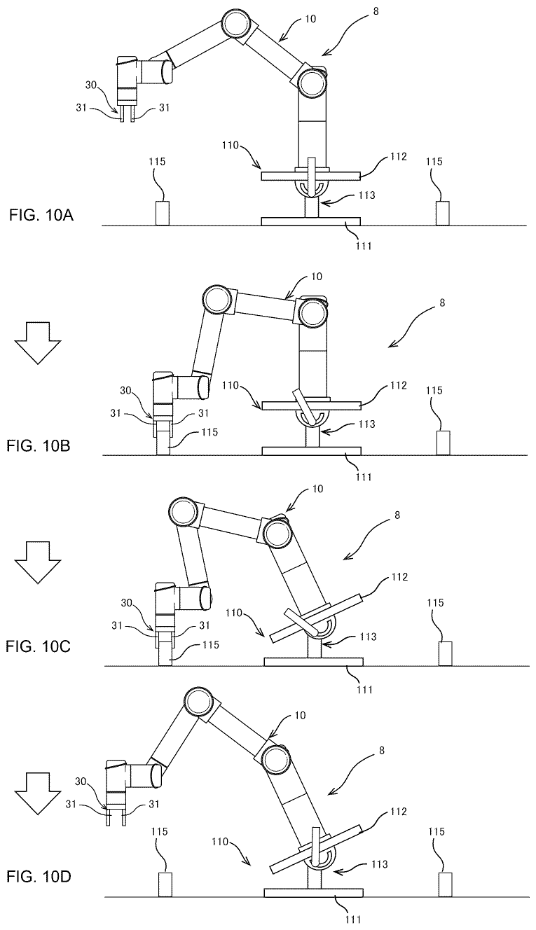

FIG. 10A to FIG. 10D show robot systems 8 according to a fourth embodiment. As shown in FIG. 10A to FIG. 10D, in the fourth embodiment, the robot arm mechanism 20 is mounted on a tiltable base 110. The base 110 has a base plate 111 fixed to the installation surface, a fixed plate 112 to which the robot arm mechanism 20 is fixed, and a tilting mechanism 113 that tilts the fixed plate 112 with respect to the base plate 111. A handle 115 is provided on the installation surface on which the base 110 is installed. The controller 40 controls the robot arm mechanism 20 to tilt the base 110. Specifically, the joint portions 21, 22, 23, 24, 25, 26 and the hand 30 are driven in order to grasp the handle 115 on the installation surface with the pair of fingers 31. Next, the joint portions 21, 22, 23, 24, 25, 26 are driven to move the hand 30 in a lifting direction. At this time, the hand side of the robot arm mechanism 20 is fixed to the handle 115, and the base 110, to which the base side of the robot arm mechanism 20 is fixed, is tiltable; therefore, the base 110 can be tilted toward the hand 30. Thus, the tilt of the robot arm mechanism 20 mounted on the base 110 with respect to the installation surface can be changed.

In this way, the robot system 8 according to the fourth embodiment has the same effects as in the first embodiment. That is, the tilt angle of the base 110 can be changed by the operation of the robot arm mechanism 20; therefore, a drive source for driving the tilting operation of the base 110 and a control device for controlling the tilt angle of the base 110 are not necessary. In addition, the operation of grasping the handle 115 by the robot arm mechanism 20 can be realized by the opening/closing operation of the hand 30 of an existing robot arm mechanism 20 and the rotation operations of the joint portions. Therefore, the robot arm mechanism 20 does not need to be equipped with a special mechanism or device only for changing the tilt angle of the base 110, and only a tilting program for tilting the base 110 needs to be prepared. Since an existing base 92 having a tilting mechanism can be used, and the robot apparatus does not need to be equipped with a dedicated mechanism or device for changing the tilt angle of the base 110, the robot system 8 according to the fourth embodiment can constitute a system capable of moving the robot arm mechanism 20 at a cost lower than systems including AGVs.

The following appendixes are further disclosed with respect to the present embodiments and modifications.

### APPENDIX 1

A robot apparatus 10 comprises a robot arm mechanism 20 mounted on a base 50, and a controller 40 to control the robot arm mechanism 20 to execute a predetermined task, and the controller 40 controls the robot arm mechanism 20 to move

### APPENDIX 2

The base 50 described in Appendix 1 includes a plurality of wheels 51, and the controller 40 controls the robot arm mechanism 20 to rotate a wheel 51.

### APPENDIX 3

The controller 40 described in Appendix 2 controls the robot arm mechanism 20 to directly grasp and rotate the wheel 51 with the hand 30 of the robot arm mechanism 20.

### Appendix 4

The controller 40 described in Appendix 2 controls the robot arm mechanism 20 to grasp and operate the handle 53 for rotating the wheel 51 with the hand 30 of the robot arm mechanism 20.

### APPENDIX 5

The robot arm mechanism 70 described in Appendix 2 includes two arms 71, 72 operations of which can be individually controlled, and the controller 40 controls the robot arm mechanism 70 to individually rotate two wheels 51 of the plurality of wheels 51 with the two arms 71, 72.

### APPENDIX 6

The controller 40 described in Appendix 2 controls the robot arm mechanism 20 to grasp a member 82 with the hand 30 of the robot arm mechanism 20, insert the grasped member 82 into a recess 85 provided on a moving path of the robot apparatus 10, and pull a base side of the robot arm mechanism 20, together with the base 80, toward the hand 30 of the robot arm mechanism 20.

### APPENDIX 7

The base 92 described in Appendix 1 is provided movably along the rail 91, and the controller 40 controls the robot arm mechanism 20 to rotate a pinion gear 94 meshed with a rack 93 arranged along the rail 91.

### APPENDIX 8

The base 92 described in Appendix 1 is provided movably along the rail 91, and the controller 40 controls the robot arm mechanism 20 to push a structure 96 provided near the rail 91 with the hand 30 of the robot arm mechanism 20 and move the base 92 away from the structure 96.

### appendix 9

The base 100 described in Appendix 1 is movable along a circular path around an axis orthogonal to an installation surface, and the controller 40 controls the robot arm mechanism 20 to move the base 100.

### APPENDIX 10

The base 110 described in Appendix 1 is tiltable with respect to an installation surface, and the controller 40 controls the robot arm mechanism 20 to tilt the base 110.

While embodiments of the present disclosure have been described in detail, the present disclosure is not limited to the individual embodiments described above. These embodiments may be subjected to various additions, substitutions, modifications, partial deletions, etc., without departing from the gist of the invention or the idea and spirit of the present invention as derived from the contents described in the claims and their equivalents. For example, in the above-described embodiments, the order of the operations and the order of the processes are shown as examples, and the present invention is not limited thereto. The same applies to the case where numerical values or formulas are used in the description of the above-described embodiments.

1. A robot apparatus comprising:
a robot arm mechanism mounted on a base; and
a controller to control the robot arm mechanism to execute a predetermined task, wherein
the controller controls the robot arm mechanism to move the base.

2. The robot apparatus according to claim 1, wherein
the base includes a plurality of the wheels, and
the controller controls the robot arm mechanism to rotate a wheel of the wheels.

3. The robot apparatus according to claim 2, wherein
The controller controls the robot arm mechanism to directly grasp and rotate the wheel with a hand of the robot arm mechanism.

4. The robot apparatus according to claim 2, wherein
the controller controls the robot arm mechanism to grasp and operate a handle for rotating the wheel with a hand of the robot arm mechanism.

5. The robot apparatus according to claim 2, wherein the robot arm mechanism includes two arms capable of being independently controlled and operated, and
the controller controls the robot arm mechanism to independently rotate two wheels of the wheels with the two arms.

6. The robot apparatus according to claim 2, wherein
the controller controls the robot arm mechanism to grasp a member with a hand of the robot arm mechanism, insert the grasped member into a recess provided on a moving path of the robot apparatus, and pull a base side of the robot arm mechanism, together with the base, toward the hand of the robot arm mechanism.

7. The robot apparatus according to claim 1, wherein
the base is provided movably along a rail, and
the controller controls the robot arm mechanism to rotate a pinion gear meshed with a rack arranged along the rail.

8. The robot apparatus according to claim 1, wherein
the base is provided movably along a rail, and
the controller controls the robot arm mechanism to push a structure provided near the rail with a hand of the robot arm mechanism and move the base away from the structure.

9. The robot apparatus according to claim 1, wherein
the base is movable along a circular path around an axis orthogonal to an installation surface, and
the controller controls the robot arm mechanism to move the base.

10. The robot apparatus according to claim 1, wherein
the base is tiltable with respect to an installation surface, and
the controller controls the robot arm mechanism to tilt the base.
